(19) United States
(12) Patent Application Publication
(10) Pub. No.: US 2024/0327610 A1
(43) Pub. Date: Oct. 3, 2024

(54) SOLUTIONS OF AMINES IN FUNCTIONAL AND NON-FUNCTIONAL RESINS

(71) Applicant: EVONIK OPERATIONS GMBH, Essen (DE)

(72) Inventors: Shafiq Fazel, Allentown, PA (US); Emmanouil Roumpelakis, Recklinghausen (DE); Gauri Sankar Lai, Whitehall, PA (US); John Hartmann, Medford, NJ (US); Douglas M. La Comare, Northampton, PA (US)

(73) Assignee: EVONIK OPERATIONS GMBH, Essen (DE)

(21) Appl. No.: 18/129,547

(22) Filed: Mar. 31, 2023

(51) Int. Cl. C08K 5/18; C09J 163/00

(52) U.S. Cl. CPC C08K 5/18; C09J 163/00

(57) ABSTRACT

The present disclosure provides for latent curing accelerators as well as compositions containing such a latent curing accelerator with a substance to be cured (e.g., an epoxy resin). The latent curing accelerators comprise an amine and an encapsulant system having at least one additional excipient selected from a functional component and/or a non-functional component. Methods of making and use are further provided.

### BACKGROUND

Compositions comprising an epoxy resin and a curing agent (hardener) have been known for decades. Many curing agents are reactive with the epoxy resin at room temperature and therefore need to be mixed just prior to use. Others known as latent hardeners are stable in admixture with the epoxy resin at ambient temperature and effect hardening only when heated to elevated temperature. Some compounds also act as accelerators of the latent curing agent, dicyandiamide (DICY) or an acid anhydride and effect cure of epoxy resins at elevated temperatures. There is a need for latent epoxy curing agents or accelerators which exhibit prolonged storage stability at ambient temperature and cure rapidly at >100° C.

U.S. Pat. Nos. 3,519,576 and 3,520,905 describe the use of salts of monomeric polyhydric phenols with polyamines as latent curing agents for epoxy resins. These compositions cure the resin rapidly at ambient temperature. U.S. Pat. Nos. 4,701,378 and 4,713,432 describe the use of salts of polymeric phenols with polyamines to accelerate epoxy cure induced by dicyandiamide (DICY), a commonly used latent curing agent. U.S. Pat. No. 4,866,133 describes the use of a solid solution of a polymeric polyhydric phenol with polyamines for curing epoxy resins. The polyamines used contain at least two amine groups with at least one being a primary amine. These curing agents are used to cure liquid epoxy resins in a concentration of at least 10 wt % relative to the epoxy resin. In U.S. Pat. No. 4,689,390 a latent curing agent was prepared by reacting a diamine bearing a tertiary amine and a primary or secondary amino group with a poly-epoxy compound and a phenolic resin or phenolic compounds. A solution of a tertiary polyamine in a poly-phenolic resin made from bisphenolic A diglycidyl ether and a polyamino secondary amine was described as a latent epoxy curing agent in U.S. patent application Ser. No. 13/075,403. U.S. Pat. No. 7,910,667 describes a polyphenolic resin solution of a polyurea derivative of a tertiary polyamine which has been used as a latent epoxy curing agent. U.S. Pat. No. 9,546,243 describes polyphenolic resin solutions of certain classes of amines which have been used as a sole latent epoxy curing agent as well as DICY accelerators. Lastly, U.S. Pat. No. 9,000,120 reports a heat-activatable DICY accelerator that consists of a tertiary amine and a Novolac resin.

There still exists a need for a lower cost, more efficient latent epoxy curing agent. Moreover, energy conservation considerations underline the need for latent epoxy curing agents and accelerators that can cure epoxy resin at lower temperatures but without sacrificing the storage stability of the epoxy formulation. The methods and curing agents cited above suffer from several disadvantages which include high use level, too low cure temperature with poor storage stability or precursor amines which are obtained by multi-step processes such as adduction with polyepoxides. Here-in we describe a new class of latent epoxy curing agents which have solved most of the problems inherent in these current curing systems and allow lower cure temperatures without compromising the latency of the one component epoxy resin compositions.

### SUMMARY

Accordingly, provided herein are epoxy curing agents and related compositions that allow for lower curing temperatures without compromising the latency of the epoxy resin composition.

We have found that it is possible to obtain epoxy curing agents having improved storage stability, low cure temperature and low use level (<10 wt. % relative to the epoxy compound) through solutions containing certain classes of amines and encapsulant systems comprising polymeric resins in combination with one or more monomeric or polymeric compounds, either of which may be functionalized with a moiety capable of interacting with tertiary amines, e.g., acidic substituents such as OH, COOH, SO₃OH, PO(OH)₃, and PO(OH)₂. Non-functional compounds or polymers do not bear these functional groups and would not interact with tertiary amines.

In a first aspect, the present disclosure is directed to a latent curing accelerator composition [Composition 1] comprising:
an amine, and
an encapsulant system comprising an additional excipient selected from a functional component (e.g., a compound or polymer functionalized by carboxy and/or hydroxy groups) and/or a non-functional component.

In some embodiments, Composition 1 is defined as follows:
1.1 Composition 1, wherein the amine is a tertiary amine.
1.2 Composition 1 or 1.1, wherein the amine is selected from at least one of:
   (a) alkyl or aryl substituted tertiary amines (e.g., mono tertiary amines);
   (b) tertiary amines with greater than two peralkylated nitrogen atoms;
   (c) tertiary amines with greater than two permethylated nitrogen atoms;
   (d) N,N-dimethyl polyamines bearing at least one primary and one secondary amine;
   (e) bridged or fused bicyclic diamines; and/or
   (f) imidazole optionally substituted with alkyl, aryl, alkyl aryl, alkyl ether, alkylamino, or at least one halogen (e.g., alkylamino substituted imidazoles, 2-alkyl or aryl substituted imidazoles, e.g., 2-methylimidazole)
1.3 Any of the preceding Compositions, wherein the amine comprises one or more of 3,3′,3″-Imino-tris-(N,N-dimethylpropylamine), 1,8-Diazabicyclo(5.4.0)undec-7-ene (DBU), triethylene diamine (TEDA), 1-(3-aminopropyl)imidazole, 2-methylimidazole, 2-ethyl-4-methylimidazole, [(dimethylamino)methyl]phenol, bis-[(dimethylamino)methyl]phenol, and tris-(dimethylaminomethyl)phenol (e.g., 2,4,6-tris-(dimethylaminomethyl)phenol), [(dimethylamino)methyl]phenol, as well as mixtures of bis- and tris-(dimethylamino)methyl-substituted phenols.
1.4 Any of the preceding Compositions, wherein the amine is an N,N-dimethyl polyamines bearing at least one primary and one secondary amine.
1.5 Any of the preceding Compositions, wherein the amine is selected from [(dimethylamino)methyl]phenol, bis-[(dimethylamino)methyl]phenol, and tris-(dimethylaminomethyl)phenol (e.g., 2,4,6-tris-(dimethylaminomethyl)phenol), and combinations thereof.
1.6 Any of the preceding Compositions, wherein the amine comprises or consists of bis-[(dimethylamino)methyl]phenol, and tris-(dimethylaminomethyl)phenol (e.g., 2,4,6-tris-(dimethylaminomethyl)phenol), and combinations thereof.
1.7 Any of the preceding Compositions, wherein the amine comprises a mixture of bis- and tris-[(dimethylamino)methyl]phenol.
1.8 Any of the preceding Compositions, wherein the amine is present in an amount of about 10 wt. % to about 75 wt. %, about 10 wt. % to about 60 wt. %, about 20 wt. % to about 60 wt. %, about 30 wt. % to about 60 wt. %, about 30 wt. % to about 50 wt. %, or about 40 wt. % to about 50 wt. % (e.g., preferably about 10 wt. % to about 60 wt. %), based on the total weight of the composition.
1.9 Any of the preceding Compositions, wherein the additional excipient is a functional compound containing one or more carboxy and/or hydroxy groups and comprises one or more of (a) an acrylic resin; (b) a polyether resin; (c) a polybutadiene resin; (d) a polyamide resin; and optionally (e) a monomeric carboxylic acid, sulfonic acid, phosphonic acid, phosphoric acid, or boric acid.
1.10 Any of the preceding Compositions, wherein the additional excipient is present in an amount of about 10 wt. % to about 75 wt. %, about 10 wt. % to about 60 wt. %, about 20 wt. % to about 60 wt. %, about 30 wt. % to about 60 wt. %, or about 40 wt. % to about 60 wt. %, (e.g., preferably about 20 wt. % to about 60 wt. %) based on the total weight of the composition.
1.11 Any of the preceding Compositions, wherein the additional excipient comprises or consists of a functional compound present in an amount of about 10 wt. % to about 75 wt. %, about 10 wt. % to about 60 wt. %, about 20 wt. % to about 60 wt. %, about 30 wt. % to about 60 wt. %, or about 40 wt. % to about 60 wt. %, (e.g., preferably about 20 wt. % to about 60 wt. %), based on the total weight of the composition.
1.12 Any of the preceding Compositions, wherein the additional excipient is a monomeric carboxylic acid, sulfonic acid, phosphonic acid, phosphoric acid, or boric acid.
1.13 Any of the preceding Compositions, wherein the additional excipient comprises or consists of a monomeric carboxylic acid.
1.14 Any of the preceding Compositions, wherein the additional excipient comprises or consists of a monomeric sulfonic acid.
1.15 Any of the preceding Compositions, wherein the additional excipient comprises or consists of a monomeric phosphonic acid.
1.16 Any of the preceding Compositions, wherein the additional excipient comprises or consists of a monomeric phosphoric acid.
1.17 Any of the preceding Compositions, wherein the additional excipient comprises or consists of a monomeric boric acid.
1.18 Any of the preceding Compositions, wherein the additional excipient comprises or a consists of an acrylic resin.
1.19 The preceding Composition, wherein the acrylic resin has a structure according to the following formula:

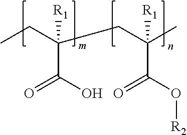

where R₁ is independently selected from H or C₁₋₃ alkyl; and
R₂ is H or C₁₋₈ alkyl, wherein the alkyl group is optionally substituted with —OH.
1.20 The preceding Composition, wherein the acrylic resin has a structure according to the following formula:

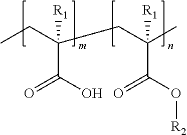

where R₁ is independently selected from H or CH₃; and
R₂ is H or C₁₋₈ alkyl, wherein the alkyl group is optionally substituted with —OH.
1.21 Any of the preceding Compositions, wherein the acrylic resin is formed by free radical polymerization of acrylic and vinyl monomers with unsaturated monomers containing hydroxy or carboxy groups.
1.22 Any of the preceding Compositions, wherein the acrylic resin is formed by free radical polymerization of acrylic monomer containing hydroxy, carboxy and/or ester groups.
1.23 Any of the preceding Compositions, wherein the acrylic resin is formed by free radical polymerization of acrylic monomer containing carboxy groups.
1.24 Any of the preceding Compositions, wherein the acrylic resin is formed by free radical polymerization of acrylic monomer containing ester groups.
1.25 Any of the preceding Compositions, wherein the acrylic resin is formed by free radical polymerization of acrylic monomer containing hydroxy groups.
1.26 Any of the preceding Compositions, wherein the acrylic resin has an acid value between about 50 to about 120 mg/KOH, about 60 to about 100 mg/KOH, or about 70 to about 90 mg/KOH (e.g., about 70 mg/KOH).
1.27 Any of the preceding Compositions, wherein the additional excipient comprises or consists of a polyether resin.
1.28 Any of the preceding Compositions, wherein the additional excipient is a polyalkylene glycol.
1.29 The preceding Composition, wherein the polyalkylene glycol has a molecular weight between about 1,000 D and about 100,000 D.
1.30 The preceding Composition, wherein the polyalkylene glycol has a molecular weight between about 1,500 D and about 35,000 D.
1.31 The preceding Composition, wherein the polyalkylene glycol has a molecular weight between about 1,500 D and about 10,000 D.
1.32 Any of the preceding Compositions, wherein the additional excipient comprises or consists of a polybutadiene resin.
1.33 The preceding Composition, wherein the polybutadiene resin is a carboxylated polybutadiene.
1.34 The preceding Composition, wherein the carboxylated polybutadiene has a polybutadiene backbone microstructure consisting of a combination of vinyl 1,2-linkage, trans 1,4-linkage and cis 1,4-linkage.
1.35 Any of Compositions 1.33-1.34, wherein the carboxylated polybutadiene has an average molecular weight between about 500 D and about 10,000 D.
1.36 Any of Compositions 1.33-1.35, wherein the carboxylated polybutadiene has a molecular weight between about 1,000 D and about 7,000 D.
1.37 Any of Compositions 1.33-1.36, wherein the carboxylated polybutadiene has a molecular structure that is composed of 70 to 90% of cis double bonds, 10 to 30% of trans double bonds and 0 to 3% of vinyl double bonds.
1.38 Any of Compositions 1.33-1.37, wherein the carboxylated polybutadiene is a maleic anhydride adduct of cis-1.4-polybutadiene (e.g., low molecular weight cis-1.4-polybutadiene), optionally having succinic anhydride pendant groups randomly distributed the polymer chain.
1.39 Any of the preceding Compositions, wherein the additional excipient comprises or consists of a polyamide resin.
1.40 The preceding Composition, wherein the polyamide resin is a nylon (e.g., nylon-6, nylon 6-6, a copolymer of nylon-6 and nylon 6-6, nylon-9, nylon-10, nylon-11, nylon-12, nylon 6-10), aromatic polyamides, elastomeric polyamides, and mixtures thereof.
1.41 Any of Compositions 1.39-1.40, wherein the polyamide resin is an acid functional thermoplastic polyamide.
1.42 Any of the preceding Compositions, wherein the additional excipient is a non-functional component is a polymeric compound selected from acrylates, polybutadienes, polyamides, ketone-aldehyde condensation resins, polyimides, styrene-butadiene resins, copolymers of olefins, and combination thereof.
1.43 Any of the preceding Compositions, wherein the additional excipient comprises or consists of a non-functional compound present in an amount of about 10 wt. % to about 75 wt. %, about 10 wt. % to about 60 wt. %, about 10 wt. % to about 50 wt. %, about 10 wt. % to about 40 wt. %, about 10 wt. % to about 30 wt. %, or about 10 wt. % to about 20 wt. % (e.g., preferably about 10 wt. % to about 30 wt. %), based on the total weight of the composition.
1.44 Any of the preceding Compositions, wherein the weight ratio of the amine to the encapsulation system is about 1:0.3 to about 1:10; or about 1:0.3 to about 1:2; or about 1:0.5 to about 1:1.5; or about 1:0.8, or about 1:1.1, or about 1:1.4.
1.45 Any of the preceding Compositions, wherein the composition is made by dissolving the amine in the encapsulant system comprising the additional excipient.
1.46 Any of the preceding Compositions, which is combined with an epoxy resin to form a curable epoxy system.
1.47 Composition 1.46, wherein the curable epoxy system has an onset temperature of about 130° C. to about 151° C.
1.48 Composition 1.46 or 1.47, wherein the curable epoxy system has an onset temperature of about 133° C. to about 146° C.
1.49 Any of Compositions 1.46-1.48, wherein the curable epoxy system has a viscosity of about 20,000 cP to about 45,000 cP.
1.50 Any of Compositions 1.46-1.49, wherein the curable epoxy system does not gel after 4 weeks under accelerated aging conditions (i.e., storage for 4 weeks at 40° C.).
1.51 Any of Compositions 1.46-1.50, wherein the curable epoxy system gives a lap shear between about 500 psi and 1700 psi.
1.52 Any of Compositions 1.46-1.51, wherein the additional excipient is an acrylic resin and the curable epoxy system gives a lap shear between about 800 psi and about 1500 psi.
1.53 Any of Compositions 1.46-1.52, wherein the curable epoxy system gives an adhesive strength as determined by a T-peel test between about 50 pli and 130 pli.
1.54 Any of Compositions 1.46-1.53, wherein the additional excipient component of the latent curing accelerator composition is an acrylic resin and the curable epoxy system gives an adhesive strength as determined by a T-peel test between about 50 pli and 130 pli.
1.55 Any of the preceding Compositions, wherein the composition is in liquid or solid powder form.
1.56 Any of the preceding Compositions, wherein the composition is in the form of an aqueous solution.
1.57 Any of the preceding Compositions, further comprising one or more of a wetting agent, filler, defoamer, and rheology modifier.
1.58 Any of the preceding Compositions, wherein the composition is a latent curing agent (e.g., the sole latent curing agent) for an epoxy resin.

In a second aspect, the present disclosure is directed to a curable epoxy system [System 1] comprising:
a latent curing accelerator composition (i.e., Composition 1, et seq.); and
an epoxy resin.

In some embodiments, System 1 is defined as follows:
1.1 System 1, wherein the latent curing accelerator composition is according to any of Composition 1, et seq.
1.2 System 1 or 1.1, wherein the epoxy is a glycidyl ether, polyhydric phenol, or cycloaliphatic epoxide (including diepoxides of cycloaliphatic esters of dicarboxylic acids).
1.3 Any of the preceding Systems, wherein the epoxy is a polymer according to the following formula:

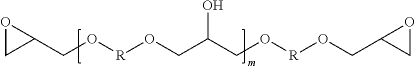

where m is an integer and R is a divalent hydrocarbon radical of a dihydric phenol.
1.4 Any of the preceding Systems, wherein the system has an onset temperature of about 130° C. to about 151° C.
1.5 Any of the preceding Systems, wherein the system has an onset temperature of about 133° C. to about 146° C.
1.6 Any of the preceding Systems, wherein the system has a viscosity of about 20,000 cP to about 45,000 cP.
1.7 Any of the preceding Systems, wherein the system does not gel after 4 weeks under accelerated aging conditions (i.e., storage for 4 weeks at 40° C.).
1.8 Any of the preceding Systems, wherein the system gives a lap shear between about 500 psi and 1700 psi.
1.9 Any of the preceding Systems, wherein the additional excipient in the latent accelerator composition is an acrylic resin and the system gives a lap shear between about 800 psi and about 1500 psi.
1.10 Any of the preceding Systems, wherein the system gives an adhesive strength as determined by a T-peel test between about 50 pli and 130 pli.
1.11 Any of the preceding Systems, wherein the additional excipient in the latent accelerator composition is an acrylic resin and the system gives an adhesive strength as determined by a T-peel test between about 50 pli and 130 pli.
1.12 Any of the preceding Systems, further comprising one or more of a wetting agent, filler, defoamer, and rheology modifier.
1.13 Any of the preceding Systems, wherein the latent accelerator composition is a latent curing agent (e.g., the sole latent curing agent) for an epoxy resin.
1.14 Any of the preceding Systems, further comprising DICY.

In a third aspect, the present disclosure is directed to a method [Method 1] for curing a substance through use of a latent curing accelerator composition comprising
an amine, and
an encapsulant system comprising an additional excipient selected from a functional component and/or a non-functional component;
the method comprising the step of combining the substance with the latent curing accelerator composition and heating the resulting mixture.

In some embodiments, Method 1 is defined as follows:
1.1 Method 1, wherein the substance is an epoxy resin.
1.2 Method 1 or 1.1, wherein the latent curing accelerator composition is according to Composition 1, et seq.
1.3 Any of the preceding Methods, wherein the mixture containing the substance with the latent curing accelerator is heated to a temperature of about 130° C. to about 151° C.
1.4 Any of the preceding Methods, wherein the mixture containing the substance with the latent curing accelerator is heated to a temperature of about 133° C. to about 146° C.
1.5 Any of the preceding Methods, wherein the latent curing accelerator composition is formed by blending the amine and the encapsulant system under nitrogen atmosphere and heating to a temperature of 130° C. to 180° C.
1.6 Any of the preceding Methods, wherein the composition is a latent curing agent (e.g., the sole latent curing agent) for an epoxy resin.
1.7 Any of the preceding Methods, wherein the composition is used as an accelerator for a curing agent such as DICY or an acid anhydride for epoxy resin.
1.8 Any of the preceding Methods, wherein the composition is used as a latent curing accelerator for structural adhesives and composites, electrical potting and encapsulation, compositions for reinforcement and/or dampening, cured in place pipe, crash durable adhesives, filament winding, transfer molding powders, prepreg with solid or liquid epoxy, sheet molding compound, coatings on concrete, wood, metal etc., resin transfer molding, and/or EV battery pack adhesives.

The disclosure further provides a latent curing accelerator composition for use in a method for curing a substance, e.g., for use in any of Methods 1, et seq.

The disclosure further provides the use of a latent curing accelerator composition in the manufacture of a curable formulation comprising a substance and the latent curing accelerator composition, e.g., for use in any of Methods 1, et seq.

### DETAILED DESCRIPTION OF THE DISCLOSURE

The present disclosure provides for latent curing accelerators as well as compositions containing such a latent curing accelerator with a substance to be cured (e.g., an epoxy resin). Methods of making and use are further provided.

### Amines

The latent curing accelerators of the present disclosure comprise at least one amine compound. Classes of amines used in the present compositions include:
(a) Alkyl or aryl substituted tertiary amines (e.g., mono tertiary amines);
(b) Tertiary amines with greater than two peralkylated nitrogen atoms;
(c) Tertiary amines with greater than two permethylated nitrogen atoms;
(d) N,N-dimethyl polyamines bearing at least one primary and one secondary amine;
(e) Bridged or fused bicyclic diamines; and
(f) imidazole optionally substituted with alkyl, aryl, alkyl aryl, alkyl ether, alkylamino, or at least one halogen (e.g., alkylamino substituted imidazoles, 2-alkyl or aryl substituted imidazoles, e.g., 2-methylimidazole).

Non-limiting examples of amines which may be used in the disclosed compositions include 3,3′,3″-Iminotris(N,N-dimethylpropylamine), 1,8-Diazabicyclo(5.4.0)undec-7-ene (DBU), triethylene diamine (TEDA), 1-(3-aminopropyl)imidazole, 2-methylimidazole, 2-ethyl-4-methylimidazole, [(dimethylamino)methyl]phenol, bis[(dimethylamino)methyl]phenol, and 2,4,6-tris(dimethylaminomethyl)phenol. Further examples of amines include mono substituted phenol compounds, such as [(dimethylamino)methyl]phenol (sold as Ancamine 1110 from Evonik Corporation), as well as mixtures of bis- and tris-dimethylaminomethyl-substituted phenols (sold as Ancamine K54 from Evonik Corporation). Other commercially available tertiary amines available from Evonik Corporation that are part of this disclosure are pentamethyldiethylenetriamine, bis(2-dimethylamino ethyl) ether, trimethylaminopropoxyethanol, bisdimethylaminopropylamine, dimethylaminopropylamine (DMAPA), and trisdimethylaminopropylamine.

The amine may be present in the latent curing accelerator composition in an amount of about 10 wt. % to about 75 wt. %, based on the total weight of the composition. In further embodiments, the amine may be present in an amount of about 10 wt. % to about 75 wt. %, about 10 wt. % to about 60 wt. %, about 20 wt. % to about 60 wt. %, about 30 wt. % to about 60 wt. %, about 30 wt. % to about 50 wt. %, or about 40 wt. % to about 50 wt. % (e.g., preferably about 10 wt. % to about 60 wt. %), based on the total weight of the composition.

### Additional Excipients

In various embodiments, the encapsulant system of the present disclosure further includes an additional excipient, which may be functional or non-functional monomeric compounds or polymeric compounds. Exemplary excipients are provided below. In various embodiments, the additional excipient may be present in an amount of about 1 wt. % to about 75 wt. %, based on the total weight of the composition. In further embodiments, the additional excipient is present in an amount of about 10 wt. % to about 75 wt. %, about 10 wt. % to about 60 wt. %, about 20 wt. % to about 60 wt. %, about 30 wt. % to about 60 wt. %, or about 40 wt. % to about 60 wt. %, (e.g., preferably about 20 wt. % to about 60 wt. %), based on the total weight of the composition. This concentration may refer to the collective amount of additional excipients or to individual additional excipients, if one or more additional excipients are present.

### Functional Compounds

Functional compounds according to the present disclosure include various chemistries such as phenols, alkyl or aryl substituted carboxylic acids, sulfonic acids, phosphoric acids, phosphonic acids and boric acids.

Representative phenolic compounds that can be used comprise at least one member selected from the group consisting of phenol or a substituted phenol (substituents include alkyl, aryl ether or amino groups or halogen atoms) for example p-tert-butylphenol, p-sec-butylphenol, o-tert-butylphenol, o-sec-butylphenol, p-tert-amylphenol, p-tert-octylphenol, p-nonylphenol, p-cumylphenol, p-dodecylphenol, styrylphenol, 2,6-di-tert-butylphenol, 2,4-di-tert-butylphenol, di-sec-butylphenol, 2,4-di-tert-amylphenol, 2,4-di-cumylphenol, o-cumyl-octylphenol, alpha-naphthol, beta-naphthol, bis-phenol A, bis-phenol F, bis-phenol TMC, and mixtures thereof.

Representative carboxylic acids that can be used comprise at least one member selected from the group consisting of acetic acid, propanoic acid, hexanoic acid, 2-ethylhexanoic acid, decanoic acid, stearic acid, benzoic acid, salicylic acid, tall oil fatty acid (TOFA), dimer acid and mixtures thereof.

It is contemplated that various other acid functional compounds may be utilized in the compositions of the present disclosure. Non-limiting examples of such compounds include sulfonic acids e.g. p-toluene sulfonic acid, methane sulfonic acid, dodecylbenzene sulfonic acid, trifluoromethane sulfonic acid, phosphonic acid, phosphoric acid, boric acids etc.

### Functional Polymeric Compounds Include Various Chemistries Such as Acrylics, Polyethers, Polybutadienes, Polyamides, and Combination Thereof Etc.

As used herein, the term “functional” or “functionalized” refers to a compound or polymer which contains or has been modified to contain one or both of a carboxy and hydroxy group.

### Acrylic Resins

The acrylic polymer useful in the disclosure can be prepared by free radical polymerization of acrylic and vinyl monomers with unsaturated monomers having hydroxy or carboxy groups. Useful acrylic resins include those having a hydroxy functionality with a hydroxy number of from >1 to 200 and carboxy functionality having an acid number from >1 to 300. The preferred softening point of acrylic polymers is from about 50° C. to 200° C.

Useful functional monomers are selected from acrylic acid, methacrylic acid, crotonic acid, hydroxyethyl acrylate, hydroxyethyl methacrylate, hydroxypropyl acrylate, and hydroxypropyl methacrylate. Other acrylic monomers can be selected from the group consisting of the esters of an α,β-ethylenically unsaturated carboxylic acid having from 3 to 8 carbon atoms. A preferred acrylic monomer has the formula:

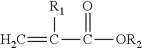

where:
   where R₁ is independently selected from H or C₁₋₃ alkyl; and
   R₂ is H or C₁₋₈ alkyl, wherein the alkyl group is optionally substituted with —OH.

Useful acrylic monomers for the compositions of the present disclosure include ethyl acrylate, butyl acrylate, isobutyl acrylate, 2-ethylhexyl acrylate, lauryl acrylate, methyl methacrylate, ethyl methacrylate, butyl methacrylate, isobutyl methacrylate, and lauryl methacrylate.

In various embodiments, the acrylic polymer can optionally contain ethylenically monounsaturated vinyl comonomer which is different from the functional monomer and the acrylic monomer. Examples of ethylenically unsaturated vinyl comonomers which can be useful are styrene, propylene, vinyl toluene, dimethyl styrene, alpha-methyl styrene, and vinyl acetate. The acrylics compounds can be liquid, solids or a solution is organic solvent.

The copolymers can be prepared in any known manner, preferably by free-radical polymerization in bulk, solution, emulsion, or suspension. Preferably, the reaction is conducted in the presence of a free radical initiator such as benzoyl peroxide, tert-butyl peroxide, decanoyl peroxide, azo compounds such as azobisisobutyronitrile, and the like. Such initiators may be present in amounts ranging from 0.1 to about 5 percent by weight of the total monomers.

In various embodiments, commercial examples of the acrylic resin used in the compositions of the present disclosure include ISOCRYL C-78 (sold by Estron Chemical Inc.), ISOCRYL H-89 (sold by Estron Chemical Inc.) AND JONCRYL 67 (sold by BASF).

### Polyether Resins

Preferred polyether resins to be used in the compositions of the present disclosure are polyalkylene glycols. The polyalkylene glycols may have molecular weights of from 1,000 to 100,000 D [Dalton], preferably from 1,500 to 35,000 D, particularly preferably from 1,500 to 10,000 D. Particularly preferred polyalkylene glycols are polyethylene glycols. Furthermore, polypropylene glycols, polytetrahydrofurans or polybutylene glycols, which are obtained from 2-ethyloxirane or 2,3-dimethyloxirane, are also suitable. Other suitable polyethers are random or block copolymers of polyalkylene glycols obtained from ethylene oxide, propylene oxide and butylene oxides, such as, for example, polyethylene glycol-polypropylene glycol block copolymers. The block copolymers may be of the AB type or of the ABA type.

Further preferred polyalkylene glycols include those which are alkylated at one terminal OH group or at both terminal OH groups. Suitable alkyl radicals are branched or straight-chain C₁₋₂₂ alkyl radicals, preferably C₁₋₁₈ alkyl radicals, for example methyl, ethyl, n-butyl, isobutyl, pentyl, hexyl, octyl, nonyl, decyl, dodecyl, tridecyl or octadecyl radicals.

The preferred polyalkylene glycols also include those which are acid capped at one terminal OH group or at both terminal OH groups. Phosphonic acid-terminated polyethers are such an example of preferred polyalkylene glycols. Another example of preferred polyalkylene glycols are polyoxyethylene chains grafted on a polycarboxylate-type backbone.

Methods of making the polyether copolymers according to the present disclosure are generally known in the prior art. The preparation is effected by free radical polymerization, preferably in solution, in nonaqueous, organic solvents or in mixed nonaqueous/aqueous solvents. Suitable preparation processes are described, for example, in WO 2007/051743 and WO 2009/013202, the disclosure of which regarding the preparation process is hereby incorporated by reference in their entireties.

### Polybutadiene Resins

Examples of the polybutadiene-based polyol resins for use in the compositions of the present disclosure include homopolymers such as 1,2-polybutadiene polyol and 1,4-polybutadiene polyol; copolymers such as poly(pentadiene butadiene)polyol, poly(butadiene styrene)polyol and poly(butadiene acrylonitrile)polyol; and hydrogenated polybutadiene-based polyol resins obtained by hydrogenation of these polyol resins. These polybutadiene-based polyol resins are commercially available, for example, from Idemitsu Kosan Co., Ltd. as Poly bd R-15HT (hydroxyl value=102.7 mg KOH/mg, Mw1200) and Poly bd R-45HT (hydroxyl value=46.6 mg KOH/mg, Mw2800).

Also, the polybutadiene-based polyol resins preferably have a hydroxyl value of 40 to 330 mg KOH/g, more preferably 40 to 110 mg KOH/g, in terms of the advantages of the present disclosure. The polybutadiene-based polyols preferably have a weight-average molecular weight (GPC) of 50 to 3,000, more preferably 800 to 1,500.

Other polybutadiene resins suitable for use in the compositions of the present disclosure include carboxylated polybutadiene, which may be in the form of a liquid polymer that is transparent at room temperature and has the polybutadiene backbone microstructure consisting of the combination of vinyl 1,2-linkage, trans 1,4-linkage and cis 1,4-linkage. The vinyl 1,2-linkage is preferably 30 wt % or less. The cis 1, 4-linkage is preferably 40 wt % or more. The cis 1, 4-linkage less than 40 wt % can lead to decreased adhesion of the resulting composition and is thus undesirable.

The carboxylated polybutadiene component can be obtained by reacting a carboxyl group-introducing compound with a liquid polybutadiene. 1,3-butadiene that composes the liquid polybutadiene and the carboxyl group-introducing compound are preferably used in respective proportions of 80 to 98% by mass (1,3-butadiene) and 2 to 20% by mass (carboxyl group-introducing compound).

The liquid polybutadiene used in the reaction preferably has a number average molecular weight of 500 to 10,000, and more preferably 1,000 to 7,000. The liquid polybutadiene desirably has a wide distribution of the molecular weight. More preferably, the liquid polybutadiene has an iodine value 30 to 500 g iodine/100 g of the material as determined according to DIN53241. Preferably, the liquid polybutadiene has a molecular structure that is composed of 70 to 90% of cis double bonds, 10 to 30% of trans double bonds and 0 to 3% of vinyl double bonds.

Examples of the carboxyl group-introducing compounds that can be used include ethylene-based unsaturated dicarboxylic compound, such as ethylene-based unsaturated dicarboxylic acids and anhydrides or monoesters thereof. Specific examples of the compounds include maleic acid, fumaric acid, itaconic acid, 3,6-tetrahydrophthalic acid, itaconic anhydride, 1,2-dimethylmaleic anhydride, maleic acid monomethyl ester or maleic acid monoethyl ester. Of these, maleic anhydride is preferred because of its safety, economy and reactivity (maleic polybutadiene is preferred).

Methods for creating the polybutadiene/maleic anhydride adduct are generally known in the prior art.

The maleic liquid polybutadiene preferably has an acid value of 50 to 120 (mg KOH/g), and more preferably 70 to 90 (mg KOH/g), as determined according to DIN ISO 3682. An acid value less than 50 (mg KOH/g) results in decreased adhesion of the resulting composition, whereas an acid value greater than 120 (mg KOH/g) leads to increased viscosity of the resulting composition, making the composition less workable.

The maleic percentage of the maleic liquid polybutadiene is preferably 6 to 20%, more preferably 6 to 15%, and even more preferably 7 to 10% although it needs to be taken into account along with the viscosity.

The viscosity of the maleic liquid polybutadiene (at 20° C.) as determined by DIN 53214 is preferably from 3 to 16 Pa s, more preferably from 5 to 13 Pa s, and even more preferably from 6 to 9 Pa s.

Further, the maleic liquid polybutadiene contains 30% or less of vinyl double bonds. A liquid polybutadiene in which cis double bonds are present within the above-specified range tends to have a higher flexibility and a higher maleic percentage (i.e., acid value) as described above as compared to a liquid polybutadiene in which the cis double bonds are present at a lower percentage than the above-specified lower limit. As a result, the composition will have a high adhesion and a sufficient polarity imparted thereto, making it possible to make a more flexible composition and to readily adjust the flexibility of the composition of the present disclosure. Further, the resulting composition has improved decorativeness.

While the viscosity of a liquid polybutadiene in which the cis double bonds are present at a lower percentage than the above-specified lower limit rapidly increases with increasing maleic percentage, the viscosity of a liquid polybutadiene having cis double bonds within the above-specified range exhibits only a small increase. The low viscosity within the above-specified range ensures high reactivity and improves workability. Also, the resulting composition has improved decorativeness.

Non-limiting examples of a polybutadiene resin according to the present disclosure is a maleic anhydride adduct of cis-1.4-polybutadiene (e.g., low molecular weight cis-1.4-polybutadiene), optionally having succinic anhydride pendant groups randomly distributed the polymer chain. Examples of such polybutadiene resins include POLYVEST OC 8005, POLYVEST OC 12005, and POLYVEST MA-75, each of which are manufactured by Evonik Industries.

### Polyamide Resins

Polyamides are typically condensation copolymers formed by reaction of dicarboxylic acids with diamines or by ring opening of lactams. Various polyamides can be created by adjusting the number of carbons. The nomenclature used herein designates the number of carbon atom in the diamine first and the number of carbons atoms in the diacid second. Therefore, Polyamide-6,6 has six carbons from the diamine, and six carbons from the diacid, and Polyamide-6,12 would have six carbons from the diamine and twelve carbons from the diacid. Polyamide-6 is a homopolymer formed by a ring-opening polymerization (i.e. ring-opening polymerization of caprolactam). The polyamide may also be nylon-9, nylon-12, nylon-11, nylon 4,6, nylon 6,10, or any of the polyamides listed herein.

The polyamide resins useful in the compositions of the present disclosure include nylon-6, nylon 6-6, a copolymer of nylon-6 and nylon 6-6, nylon-9, nylon-10, nylon-11, nylon-12, nylon 6-10, aromatic polyamides, elastomeric polyamides, and mixtures thereof.

The conditions for preparing a polyamide resin and the COOH/NH₂ ratio can be chosen such that end products are obtained which have an acid value or amine value which is within the intended range of values. A polyamide resin is classified as acid functional in case its amine value is lower than its acid value (AV). A resin is classified as amine functional in case its acid value is lower than its amine value. Evonik's ANCATHERM 592 is an example of acid functional thermoplastic polyamide.

### Non-Functional Polymeric Compounds

Non-functional polymeric compounds useful for the compositions of the present disclosure include acrylates, polybutadienes, polyamides, ketone-aldehyde condensation resins, polyimides, styrene-butadiene resins as well as copolymers of other olefins and combination thereof.

Examples of non-functional resin compounds that can be used according to the present disclosure include compounds from Evonik's POLYVEST liquid polybutadienes product line, thermoplastic acrylic resins and MBS polymers from Dow's Paraloid product line, non-functional polyamides from Evonik's Vestamid product line, styrenic block copolymers (SBC) from Kraton made from butadiene, styrene and isoprene raw materials and finally, ketone-aldehyde condensation resins such as Evonik's TEGO Variplus AP can also be used in the compositions of the present disclosure.

### Curable Epoxy Resins

The solutions of the amines with other resins and combinations described above are used as curing agents for epoxy resins. Epoxy resins commercially available under the trade name DER 383 or DER 333 (available from Dow) and EPON 826 or EPON 828 (available from Hexion Specialty Chemicals) are suitable for use with the latent curing accelerator compositions of the present disclosure.

Other epoxy resins may include, but are not limited to, bi-functional epoxies, such as, bisphenol-A and bisphenol-F resins. Multifunctional epoxy resin, as utilized herein, describes compounds containing two or more 1,2-epoxy groups per molecule. Epoxide compounds of this type are well known to those of skill in the art and are described in Y. Tanaka, “Synthesis and Characteristics of Epoxides,” in C. A. May, ed., Epoxy Resins Chemistry and Technology (Marcel Dekker, 1988), which is incorporated herein by reference.

One class of epoxy resins suitable for use in the present disclosure comprises the glycidyl ethers of polyhydric phenols, including the glycidyl ethers of dihydric phenols. Illustrative examples include, but are not limited to, the glycidyl ethers of resorcinol, hydroquinone, bis-(4-hydroxy-3,5-difluorophenyl)-methane, 1,1-bis-(4-hydroxyphenyl)-ethane, 2,2-bis-(4-hydroxy-3-methylphenyl)-propane, 2,2-bis-(4-hydroxy-3,5-dichlorophenyl) propane, 2,2-bis-(4-hydroxyphenyl)-propane (commercially known as bisphenol A), bis-(4-hydroxyphenyl)-methane (commercially known as bisphenol-F, and which may contain varying amounts of 2-hydroxyphenyl isomers), and the like, or any combination thereof. Additionally, advanced dihydric phenols of the following structure also are useful in the present disclosure:

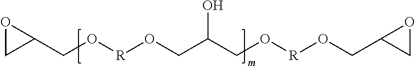

where m is an integer and R is a divalent hydrocarbon radical of a dihydric phenol, such as those dihydric phenols listed above.

Materials according to this formula can be prepared by polymerizing mixtures of a dihydric phenol and epichlorohydrin, or by advancing a mixture of a diglycidyl ether of the dihydric phenol and the dihydric phenol. While in any given molecule the value of m is an integer, the materials are invariably mixtures which can be characterized by an average value of m which is not necessarily a whole number. Polymeric materials with an average value of m between 0 and about 7 can be used in one aspect of the present disclosure. In other embodiments, the epoxy component may be a polyglycidyl amine from one or more of 2,2′-methylene dianiline, m-xylene dianiline, hydantoin, and isocyanate.

The epoxy component may be a cycloaliphatic (alicyclic) epoxide. Examples of suitable cycloaliphatic epoxides include diepoxides of cycloaliphatic esters of dicarboxylic acids such as bis(3,4-epoxycyclohexylmethyl)oxalate, bis(3,4-epoxycyclohexylmethyl)adipate, bis(3,4-epoxy-6-methylcyclohexylmethyl)adipate, vinylcyclohexene diepoxides; limonene diepoxide; bis(3,4-epoxycyclohexylmethyl)pimelate; dicyclopentadiene diepoxide; and other suitable cycloaliphatic epoxides. Other suitable diepoxides of cycloaliphatic esters of dicarboxylic acids are described, for example, in WO 2009/089145 A1, which is hereby incorporated by reference.

Other cycloaliphatic epoxides include 3,3-epoxycyclohexylmethyl-3,4-epoxycyclohexane carboxylate such as 3,4-epoxycyclohexylmethyl-3,4-epoxycyclohexane carboxylate; 3,3-epoxy-1-methylcyclohexyl-methyl-3,4-epoxy-1-methylcyclohexane carboxylate; 6-methyl-3,4-epoxycyclohexylmethylmethyl-6-methyl-3,4-epoxycyclohexane carboxylate; 3,4-epoxy-2-methylcyclohexyl-methyl-3,4-epoxy-3-methylcyclohexane carboxylate. Other suitable 3,4-epoxycyclohexylmentyl-3,4-epoxycyclohexane carboxylates are described, for example, in U.S. Pat. No. 2,890,194, which is hereby incorporated by reference. In other embodiments, the epoxy component may include polyol polyglycidyl ether from polyethylene glycol, polypropylene glycol or polytetrahydrofuran or combinations thereof.

In addition to the components discussed above, the latent curing accelerators may be used in curable epoxy compositions optionally further comprise additives such as wetting agents (e.g., silicones, fatty acid alcohols, ionic and nonionic surfactants etc.); fillers (e.g., calcium carbonate, calcium oxide, talc, coal tar, carbon black, textile fibers, glass particles or fibers, aramid pulp, boron fibers, carbon fibers, mineral silicates, mica, powdered quartz, hydrated aluminum oxide, bentonite, wollastonite, kaolin, fumed silica, silica aerogel or metal powders such as aluminum powder or iron powder); defoamers (e.g., nonionic surfactants, silicone, mineral oils etc.); rheology modifiers(e.g., fumed silica, bentonite clay, organoclay, precipitated calcium carbonate etc.); etc.

In various embodiments, the latent curing accelerator compositions of the present disclosure are prepared by first charging the components under a N₂ atmosphere into a 2-piece glass reactor equipped with a mechanical stirrer, a thermocouple and a reflux condenser. The reaction components are heated to 130-180° C. for a period of time, e.g., 1 hour, and the hot solution is poured onto a Teflon block or aluminum sheet and allowed to cool to room temperature. The resins can be added into the reactor either neat as described above or dissolved in some type of polar solvent such methanol. In the latter case, the resulting reaction mixture is refluxed for two hours to form a clear solution. The mixture is then cooled to room temperature and the solvent is removed by evaporation. The resulting product is further dried under vacuum.

Once removed from reactor, the final curing agent formulation can be a liquid or a solid. If it is a solid, the material is ground to a fine powder using spray drying, milling with ceramic beads, jet milling, coffee grinding, etc. Particle size of the powder can range between 1 micron to 100 microns. The powder is then incorporated into the epoxy resin and mixed using a speed mixer, Cowles blade mixer or planetary mixer, etc. If the final curing agent is a liquid, it is directly incorporated into the resin using similar mixing methods. Optional additives such as wetting agents, fillers, defoamers, rheology modifiers, etc. can be added if necessary.

The curing agent of this composition can be used to cure the epoxy resin as a sole component or as an accelerator with DICY. In addition, it can be used as an accelerator for anhydride cured epoxy; polymercaptan cured epoxy and other amine cured epoxy.

An epoxy formulation containing the curing agent of this composition either as a sole curing or as an accelerator, can be used in various applications where an epoxy system is preferred. Applications of particular interest include but not limited to structural adhesives and composites, electrical potting and encapsulation, compositions for reinforcement and/or dampening, cured in place pipe, crash durable adhesives, filament winding, transfer molding powders, prepreg with solid or liquid epoxy, sheet molding compound, coatings on concrete, wood, metal etc., resin transfer molding, and EV battery pack adhesives.

### EXAMPLES

### Example 1: Preparation of Amine Solutions in Acrylic Resins

The amine is added to a 2-piece glass reaction flask under a N₂ atmosphere and heated to 130-180° C. The non-phenolic resin is slowly added with stirring. On completion of addition, the mixture is held at 130-180° C. for an additional period of 1 h. The molten solution is poured on to a Teflon block or aluminium sheet and allowed to cool to room temperature. The solid product is ground by a coffee grinder and subsequently micronized to the appropriate size at a speed mixer using ceramic beads. This method is used to prepare the following solutions of amines.

### (a) Formulation 1: 2,4,6-tris(dimethylaminomethyl)phenol (Ancamine K54) solution in acrylic resin Joncryl 67

Weight ratios of amine to acrylic resin of 100/140, 100/110 and 100/80 were prepared as follows. Prepared as above using 110 g 2,4,6-tris(dimethylaminomethyl)phenol and 154 g of acrylic resin. A second blend was prepared using 125 g 2,4,6-tris(dimethylaminomethyl)phenol and 137.5 g acrylic resin. A third blend was also prepared using 125 g 2,4,6-tris(dimethylaminomethyl)phenol and 100 g acrylic resin. The preparations of Formulation 1 are summarized below.

TABLE 1

| | Formulation 1a | Formulation 1b | Formulation 1c |
|---|---|---|---|
| Ancamine | 41.7% | 47.6% | 55.6% |
| K54 wt. % | | | |
| Joncryl | 58.3% | 52.4% | 44.4% |
| 67 wt. % | | | |

### (b) Formulation 2: 2,4,6-tris(dimethylaminomethyl)phenol (Ancamine K54) solution in acrylic resins Joncryl 67 and Epomatt G-152

Weight ratios of amine to acrylic resins of 100/140, 100/110 and 100/80 were prepared as follows. Joncryl 67 to Epomatt G-152 resin weight ratio used in this example is 50/50. Prepared as above using 110 g 2,4,6-tris(dimethylaminomethyl)phenol, 77 g of each acrylic resin (Joncryl 67 and Epomatt G-152). A second blend was prepared using 125 g 2,4,6-tris(dimethylaminomethyl)phenol, 68.75 g of each acrylic resin. Also prepared using 125 g 2,4,6-tris(dimethylaminomethyl)phenol and 50 g of each acrylic resin. The preparations of Formulation 2 are summarized below.

TABLE 2

| | Formulation 2a | Formulation 2b | Formulation 2c |
|---|---|---|---|
| Ancamine | 41.6% | 47.6% | 55.6% |
| K54 wt. % | | | |
| Joncryl | 29.2% | 26.2% | 22.2% |
| 67 wt. % | | | |
| Epomatt | 29.2% | 26.2% | 22.2% |
| G-152 wt. % | | | |

### Example 2: Differential Scanning Calorimetry (DSC) of Amine Solutions in Polymeric and Monomeric Functional and Non-Functional Resins

### DSC as DICY Accelerator

Samples of the amine solutions of Example 1 were mixed with dicyandiamide (DICY), fumed silica and bisphenol A diglycidyl ether (2:6:2:100 mass ratio). The mixtures were analyzed by DSC (TA instruments QA20, Software V24.10 Build 122) to determine the onset cure temperature, heat of reaction (ΔH) and glass transition temperature (Tg). The DSC was operated in accordance with standard methods using software included in the DSC. The samples were heated from −25° C. to 300° C. at a heating rate of 10° C. per minute. Neat 2,4,6-tris(dimethylaminomethyl)phenol was used as a reference accelerator. The results are shown in the table below.

| Accelerator/DICY/ | Onset | | |
|---|---|---|---|
| silica/EPON8282/6/ | temp. | ΔH | Tg |
| 2/100 parts per weight | (° C.) | (J/g) | (° C.) |
| Ancamine K54 | 113 | 423 | 122 |
| K54/Joncryl 67 (100/110) | 140 | 418.4 | 125 |
| K54/Joncryl 67-Epomatt | 134 | 435.4 | 125 |
| G-152 (100/110) | | | |

### Example 3: Latency of Amine Solutions in Polymeric and Monomeric Functional and Non-Functional Resins

Samples of the amine solutions of Example 1 were mixed with dicyandiamide (DICY), fumed silica and bisphenol A diglycidyl ether (2:6:2:100 mass ratio) and the latency of the resulting epoxy formulations was monitored as viscosity change upon aging at 40° C. by a Brookfield Cone and Plate viscometer (model HADV II+CP) with a #52 spindle at 25° C. using 0.5 mL sample. Also shelf stability was determined by visual observation to determine gelation time. The results are shown in the table below.

| Accelerator/DICY/ | Initial | % Visc. |
|---|---|---|
| silica/EPON8282/6/ | Viscosity, | Increase after |
| 2/100 parts per weight | cP | 4 weeks@40° C. |
| Ancamine K54 | — | Gelled after |
| | | 24 h at r.t. |
| K54/Joncryl 67 (100/110) | 20,880 | 25% |
| K54/Joncryl 67-Epomatt | 20,080 | 36% |
| G-152 (100/110) | | |

### Example 4: Adhesion Properties

The adhesion properties of a simple epoxy adhesive formulation that contains the curing agents of Example 1 were measured by the Lap Shear and T-Peel techniques. The Lap shear measurements were conducted on an Instron Model 1125 instrument according to the Lap Shear ASTM method D1876 with at least five replicates. The test materials were applied to a 1″X04″X0.32″ cold rolled steel panel (ACT Cold Roll Steel 01X04X032 B952 P60 DIW: Unpolished). The materials were applied with 10 mil glass beads (1% based on formulation weight) to ½″ ends of the coupon. Another coupon was laid on top overlapping the ½″ bands on the other coupon. The panels with test materials were cured for 15-30 min at temperatures between 130° C. and 160° C., and then, let cool down to room temperature before measurement.

The T-peel measurement was conducted on an Instron Model 1125 instrument according to the Lap Shear ASTM method D1876 with at least five replicates. The test materials were applied to a 1″X4″X0.32″ cold rolled steel panel (ACT Cold Roll Steel 01X04X032 B952 P60 DIW: Unpolished) pre-bent at right angle at ⅞″ from the end, leaving 3⅛″X 1″ surface. The materials were applied with 10 mil glass beads (1% based on formulation weight). The test materials were cured for 15-30 min at temperatures between 130° C. and 160° C., and then, let cool down to room temperature before measurement. The results of the Lap Shear and T-Peel measurements are shown in the table below:

| Accelerator/DICY/ | | |
|---|---|---|
| silica/EPON8282/6/ | Lap | T-Peel |
| 2/100 parts per weight | Shear (psi) | (pli) |
| Ancamine K54 | 1121 | 110 |
| K54/Joncryl 67 (100/110) | 949 | 86 |
| K54/Joncryl 67-Epomatt | 1082 | 71 |
| G-152 (100/110) | | |

While the invention has been described with reference to certain aspects or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular aspect or embodiment disclosed as the best mode contemplated for carrying out this invention, but that the invention will include all embodiments falling within the scope of the appended claims including using the aspects or embodiments of the invention alone or in combination with each other.

1. A latent curing accelerator composition comprising:
an amine, and
an encapsulant system comprising an additional excipient selected from a functional component and/or a non-functional component.

2. The composition according to claim 1, wherein the amine is selected from at least one of:
(a) alkyl or aryl substituted tertiary amines (e.g., mono tertiary amines);
(b) tertiary amines with greater than two peralkylated nitrogen atoms;
(c) tertiary amines with greater than two permethylated nitrogen atoms;
(d) N,N-dimethyl polyamines bearing at least one primary and one secondary amine;
(e) bridged or fused bicyclic diamines; and/or
(f) imidazole optionally substituted with alkyl, aryl, alkyl aryl, alkyl ether, alkylamino, or at least one halogen (e.g., alkylamino substituted imidazoles, 2-alkyl or aryl substituted imidazoles, e.g., 2-methylimidazole).

3. The composition according to claim 2, wherein the amine comprises one or more of 3,3′,3″-Imino-tris-(N,N-dimethylpropylamine), 1,8-Diazabicyclo(5.4.0)undec-7-ene (DBU), triethylene diamine (TEDA), 1-(3-aminopropyl)imidazole, 2-methylimidazole, 2-ethyl-4-methylimidazole, [(dimethylamino)methyl]phenol, bis-[(dimethylamino)methyl]phenol, and tris-(dimethylaminomethyl)phenol (e.g., 2,4,6-tris-(dimethylaminomethyl)phenol), [(dimethylamino)methyl]phenol, as well as mixtures of bis- and tris-(dimethylamino)methyl-substituted phenols.

4. The composition according to claim 3, wherein the amine is selected from [(dimethylamino)methyl]phenol, bis-[(dimethylamino)methyl]phenol, and tris-(dimethylaminomethyl)phenol (e.g., 2,4,6-tris-(dimethylaminomethyl)phenol), and combinations thereof.

5. The composition according to claim 1, wherein the additional excipient is a functional polymeric compound, e.g., a polymeric compound containing one or more carboxy and/or hydroxy groups.

6. The composition according to claim 5, wherein the additional excipient is selected from one or more of a polyamide resin, a polybutadiene resin, a polyether resin, and an acrylic resin.

7. The composition according to claim 6, wherein the additional excipient is an acrylic resin.

8. The composition according to claim 7, wherein the acrylic resin has a structure according to the following formula: 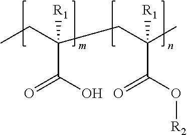
where R₁ is independently selected from H or C₁₋₃ alkyl; and
R₂ is H or C₁₋₃ alkyl, wherein the alkyl group is optionally substituted with —OH.

9. The composition according to claim 7, wherein the acrylic resin is formed by free radical polymerization of acrylic and vinyl monomers with unsaturated monomers containing hydroxy or carboxy groups.

10. The composition according to claim 7, wherein the acrylic resin is formed by free radical polymerization of acrylic monomer containing hydroxy, carboxy and/or ester groups.

11. The composition according to claim 6, wherein the additional excipient is a polybutadiene resin.

12. The composition according to claim 6, wherein the additional excipient is a polyamide resin.

13. The composition according to claim 6, wherein the weight ratio of the amine to the encapsulation system is about 1:0.3 to about 1:10; or about 1:0.3 to about 1:2; or about 1:0.5 to about 1:1.5; or about 1:0.8, or about 1:1.1, or about 1:1.4.

14. The composition according to claim 6, which is combined with an epoxy resin to form a curable epoxy system, wherein the curable epoxy system does not gel after 4 weeks under accelerated aging conditions (e.g., storage for 4 weeks at 40° C.).

15. The composition according to claim 6, which is combined with an epoxy resin to form a curable epoxy system, wherein the curable epoxy system gives a lap shear of at least 500 psi, e.g., between about 500 psi and 1700 psi.

16. A method for curing a substance through use of a latent curing accelerator composition comprising
an amine, and
an encapsulant system an additional excipient selected from a functional component and/or a non-functional component;
the method comprising the step of combining the substance with the latent curing accelerator composition and heating the resulting mixture.

17. The method according to claim 17, wherein the substance is an epoxy resin.

18. The method according to claim 17, wherein the composition is a latent curing agent (e.g., the sole latent curing agent) for an epoxy resin, or wherein the composition is used as an accelerator for a curing agent such as DICY or an acid anhydride for epoxy resin.

19. The method according to claim 18, wherein the composition is used as a latent curing accelerator for structural adhesives and composites, electrical potting and encapsulation, compositions for reinforcement and/or dampening, cured in place pipe, crash durable adhesives, filament winding, transfer molding powders, prepreg with solid or liquid epoxy, sheet molding compound, coatings on concrete, wood, metal etc., resin transfer molding, and/or EV battery pack adhesives.
